(19) United States
(12) Patent Application Publication
(10) Pub. No.: US 2007/0098534 A1
(43) Pub. Date: May 3, 2007

(54) Vehicular cargo loading and storage

(76) Inventor: Elizabeth Bergman, Parker, CO (US)

Correspondence Address: HANES & SCHUTZ, LLC, 102 SOUTH TEJON ST., SUITE 800, COLORADO SPRINGS, CO, 80903, US

(21) Appl. No.: 11/260,746

(22) Filed: Oct. 28, 2005

(51) Int. Cl. B60P 1/04

(52) U.S. Cl. 414/483

(57) ABSTRACT

A transport vehicle comprising a vehicular frame, including running gear, having a U shaped opening in the rear end thereof defined by spaced apart vehicle side frame members and a perpendicular bottom frame member, a pair of spaced apart telescoping beams having a plurality of coaxial extendable sections, including proximal and distal end sections, where the proximal end sections are attached respectively to the side frame members of the vehicle and where the distal end sections include ground contacting support wheels.

### FIELD OF THE INVENTION

The present invention relates to apparatus for loading and storage of cargo within an enclosed vehicular compartment.

### BACKGROUND OF THE INVENTION

Enclosed vehicular transport vehicles such as recreational vehicles and motor homes are often called upon to transport loads such as boats, trailers automobiles and similar cargo. When such cargo has wheels it may be towed, however towing a boat behind a large recreational vehicle has several disadvantages, including security of the boat and driving problems created by the total length of the combination.

It is therefore, the primary object of the present invention to provide apparatus for loading non-wheeled cargo, such as a boat, into a vehicular compartment.

It is another object of the present invention to provide cargo loading and securing apparatus that is adaptable to all types of compartmental vehicles from semi-trailers to recreational vehicles.

Other objects, features and advantages of the present invention will become apparent on a reading of the following specification taken in conjunction with the accompanying drawings.

### SUMMARY OF THE INVENTION

The apparatus of the present invention is intended to be incorporated into a transport vehicle having a frame, running gear and a body into or on which cargo may be loaded and stored for transport. The transport vehicle is preferably self-propelled, such as a recreational vehicle. The enclosed body of the vehicle of the present invention is mounted on a vehicular frame having a U shaped open portion under the rear of the vehicle body and includes a floor having a longitudinally elongated opening over the U shaped portion of the frame. Two spaced apart telescoping beams are disposed beneath the floor opening and are secured to the side members of the U shaped portion of the vehicle frame. The distal end of each beam is supported by a ground contacting wheel. Mounted on the distal end section of the telescoping beams is a cantilevered cargo support structure that extends forwardly.

Loading a boat, for example, is accomplished by positioning the transport vehicle on a boat loading ramp and extending, by hydraulic or electrical drive, the telescoping beams rearwardly of the rear opening in the transport vehicle and into the water where the boat is driven onto the cantilevered cargo support structure in the same manner as when loading a boat onto a trailer. When the boat is secured to the cargo support structure the telescoping beams are retracted, bringing the boat into the interior of the recreational vehicle with the hull of the boat positioned over the opening in the floor of the vehicle. In other embodiments the transport vehicle may be open, such as a flat bed trailer or it can be closed in the fashion of a semi-trailer or the referenced recreational vehicle.

### DESCRIPTION OF THE DRAWINGS

FIG. 1 is a perspective view of the telescoping beams and the cantilevered cargo support structure of the present invention.

FIG. 2A is a fragmentary perspective view of the rear portion of a vehicular frame showing the telescoping beams of the present invention in their extended position and showing the outline of the body of the vehicle in dotted lines.

FIG. 2B is similar to FIG. 2 except that the telescoping beams are shown in their retracted position.

FIG. 3 is a rear end view of the vehicle frame, telescoping beams and cantilevered cargo supports, with a rear fragmentary dotted outline of an exemplary boat in position on the supports.

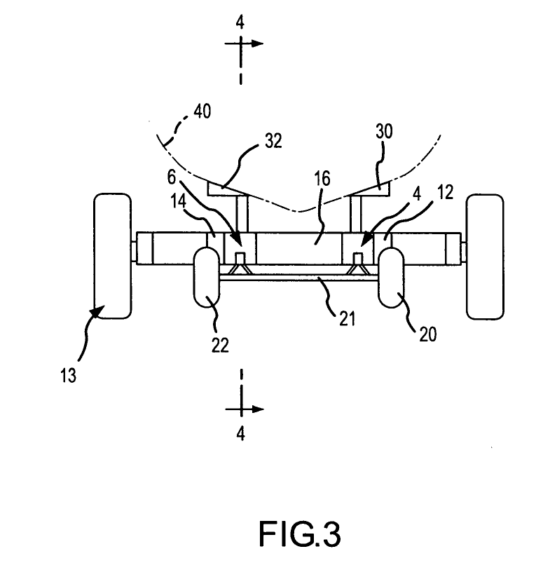

FIG. 4 is a cross section taken along lines 4-4 of FIG. 3 including a side view in dotted lines of an exemplary boat at rest on the cargo support structure.

FIG. 5 is a top view of the apparatus of the present invention in its extended position, shown in solid lines, and a top view of the apparatus in its retraced position shown in dotted lines, along with an exemplary dotted line showing of the boat and the body of the transport vehicle.

### DETAILED DESCRIPTION OF PREFERRED EMBODIMENT

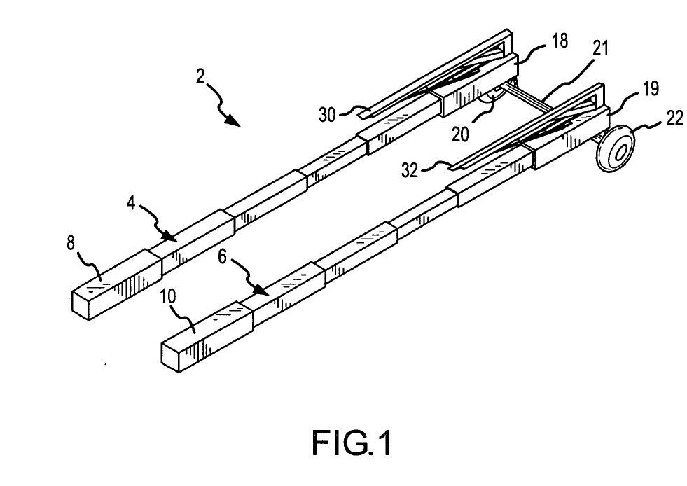

The cargo loading device 2 of the present invention is illustrated in FIG. 1 and will be described in terms of its function in loading and transporting a small boat as the cargo within the interior of a recreational or similar vehicle 3. Other items of cargo are clearly within the intent of the invention.

Two telescoping beams 4 and 6 are provided with respective proximal end sections 8 and 10 that are attached to side frame members 12 and 14 and a bottom frame member 16 that together define a U shaped opening in the rear portion of the vehicle frame 11 that is supported by rear running gear 13. Distal end sections 18 and 19 of the respective beams 4 and 6 are each supported by wheels 20 and 22 that are interconnected by an axel 21. Each of the beams is equipped with a hydraulic cylinder 24 having an operable piston 25. In a manner well know to the hydraulic art, the piston is made to either extend the distal end sections or retract them, depending on which side of the hydraulic piston pressure is applied by a valve that directs the pressure to one side of the piston or the other. An electrical motor and associated driving levers could also provide the power to extend and retract the telescoping beams.

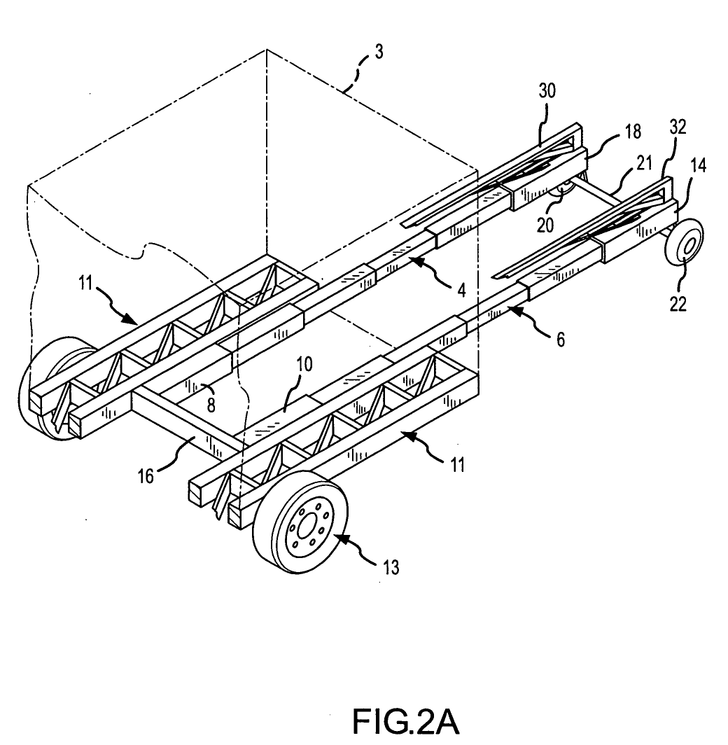

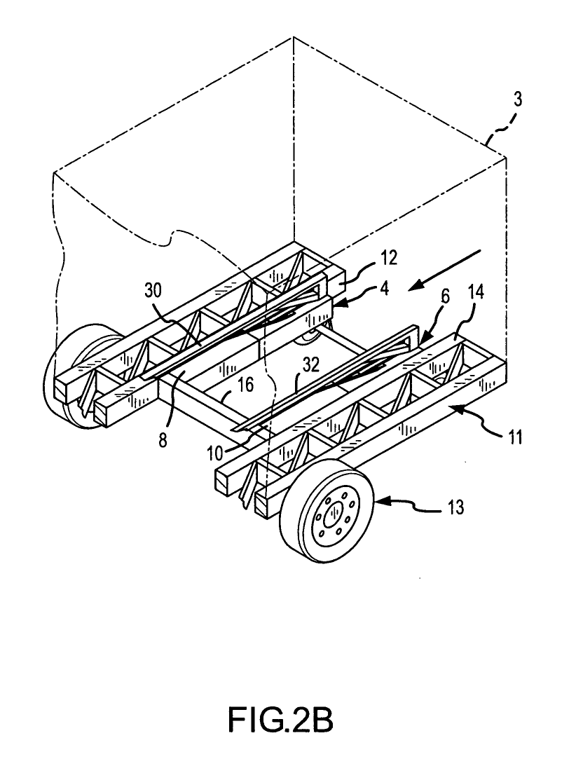

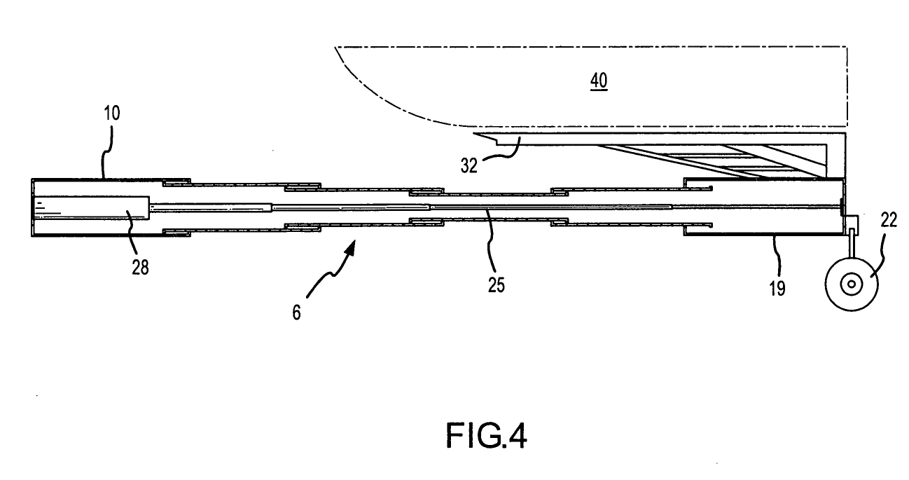

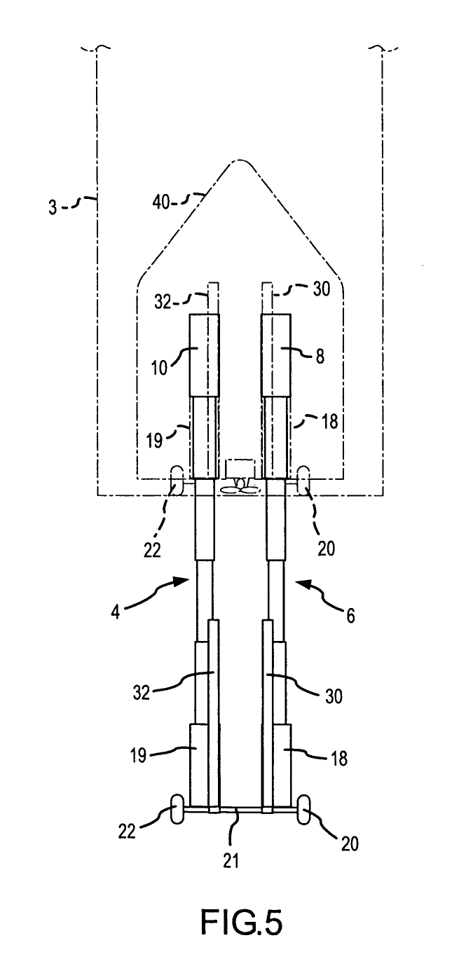

Mounted in a cantilever manner on the distal sections 18 and 19 of each telescoping beam are elongated support arms 30 and 32. These support arms cradle the hull of a boat 40 in much the same way as similar supports operate in a typical boat trailer. When the telescoping beams are extended to the position shown in FIGS. 1, 2A, 4 and 5 the wheels 20 and 22 would typically be positioned in the lake water so that the boat 40 can be driven onto the support arms 30 and 32. Once the boat is secured to the support arms the telescoping beams are retracted to bring the boat into a position within an opening in the floor of the transport vehicle, as shown in FIG. 2B. For clarity the floor of the vehicle is not shown in FIG. 2B, however the opening in the floor disposed over the frame is coincident with the U shaped opening in the vehicle frame 11.

What is claimed is:

1. A transport vehicle comprising,
a vehicular frame, including running gear, having a U shaped opening in the rear end thereof defined by spaced apart vehicle side frame members and a perpendicular bottom frame member,
a pair of spaced apart telescoping beams having a plurality of coaxial extendable and retractable sections, including at least proximal and distal end sections, where the proximal end sections are attached respectively to at least the side frame members of the vehicle and where the distal end sections include at least one ground contacting support wheel.

2. The vehicle of claim 1 and further including cargo supporting means mounted on the distal ends of the telescoping beams.

3. The vehicle of claim 2 where the cargo supporting means include cargo support rails that are cantilevered over the respective beams.

4. The vehicle of claim 1 and further including power means mounted internally of each telescoping beam for extending and retracting the beam.
